(19) United States
(12) Patent Application Publication
(10) Pub. No.: US 2025/0326879 A1
(43) Pub. Date: Oct. 23, 2025

(54) RESIN COMPOSITION FOR OPTICAL WAVEGUIDES, RESIN COMPOSITION FOR SUBSTRATE WITH OPTICAL WAVEGUIDE, RESIN FILM, CURED OBJECT, AND OPTICAL CIRCUIT BOARD

(71) Applicant: NIPPON KAYAKU KABUSHIKI KAISHA, Tokyo (JP)

(72) Inventors: Mai TSUBAMOTO, Tokyo (JP); Kazuteru SHIRAI, Tokyo (JP); Kazuyoshi YAMAMOTO, Tokyo (JP); Yasuhiro HOZUMI, Tokyo (JP); Mao TAKEDA, Tokyo (JP)

(73) Assignee: NIPPON KAYAKU KABUSHIKI KAISHA, Tokyo (JP)

(21) Appl. No.: 18/863,878

(22) PCT Filed: Apr. 28, 2023
(86) PCT No.: PCT/JP2023/016847

§ 371 Date: Nov. 7, 2024

(30) Foreign Application Priority Data
May 13, 2022 (JP) 2022-079430

(51) Int. Cl. C08F 283/04; G02B 6/122; G02B 6/138

(52) U.S. Cl. CPC C08F 283/04; G02B 6/1221; G02B 6/138

(57) ABSTRACT

A purpose of the present invention is to provide a resin composition suitable for optical communication technologies. Another purpose is to provide a resin composition which can be used as the insulating resin of re-wiring layers for electronics and also as the clad resin of optical polymer waveguides and which is suitable for filling the gap between chips, chip boards, etc. in order to protect the wiring and to make it possible to produce highly integrated, energy-saving, multifunctional devices based on various package structures including co-packaged optics. The present inventors diligently made investigations and, as a result, have discovered that a composition comprising a photocurable resin and a bismaleimide compound is useful as a resin composition for optical waveguides, thereby completing the invention.

### TECHNICAL FIELD

The present invention relates to a resin composition for optical waveguides, a resin composition for a substrate with an optical waveguide, a resin film, a cured object, and an optical circuit board.

### BACKGROUND ART

In recent years, there has been a demand for the use of optical circuit boards to solve the heat generation problem of circuit boards used in base station servers, which are part of the communications infrastructure, and to achieve energy conservation. However, because optical communications is made up of a combination of individual components, advanced integration technology has not yet been established.

Furthermore, technology for simultaneously mounting electrical and optical wiring (co-packaging) in order to achieve advanced integration technology on existing circuit boards (package boards with IC chips mounted on them) has not yet been established.

In existing circuit boards, the redistribution layer on the package substrate on which the chip is mounted is known to be composed of copper wiring of several microns derived from copper foil and an insulating resin composition.

On the other hand, optical fibers of several tens of microns are mainly used for wiring in photonics (optical communication), but it is expected that polymer optical waveguides will be applied due to the progress of miniaturization to several microns to submicron units.

The integration of many devices is being considered to achieve high-density packaging of low-power optical communications, and optoelectronic integrated packaging technology (co-packaged optics), a technology that simultaneously implements electrical communication technologies and optical communications technologies, is being considered. A package substrate structure has begun to be proposed in which optical communication devices, which have conventionally been mounted as individual components, are miniaturized and integrated into a chip size, and mounted together with telecommunications IC chips.

Patent Literature 1 discloses that in a package substrate on which an optoelectronic chip obtained from a Ill-V compound semiconductor wafer is mounted, a difference in coefficient of linear expansion (CTE) between the IC chip obtained from a silicon wafer becomes an issue during mounting.

Patent Literature 2 discloses a configuration in which a photonics chip is mounted in a form of being stacked on a FOWLP (Fan Out Wafer Level Package).

Patent Literature 3 discloses a configuration in which a silicon photonics chip having an optical transceiver function is mounted on a substrate.

In both cases, specific configurations of optoelectronic integrated packaging are shown, and insulating resin is required for the redistribution layer (RDL) that fills gaps to protect wiring between chips and between chips and boards.

Furthermore, Patent Literature 4 discloses an epoxy resin composition characterized by its optical transparency as a selective wavelength absorbing composition for LIDAR (Laser Imaging Detection and Ranging) having a light transmittance of 70% or more at 1550 nm, which is less likely to discolor due to heat and has high stability against light.

On the other hand, Patent Literature 5 discloses that a resin composition containing a bismaleimide resin is suitable for a redistribution layer of electronics.

Non-Patent Literature 1 indicates a trend toward mounting a package of an optical communication device, which is miniaturized and highly integrated on a silicon wafer, and an existing large scale integrated circuit (LSI chip) on the same substrate.

### CITATION LIST

### Patent Literature

Patent Literature 1: U.S. Patent Application Publication No. 2021/0088737
Patent Literature 2: U.S. Patent Application Publication No. 2018/0275359
Patent Literature 3: U.S. Pat. No. 10,025,047
Patent Literature 4: Japanese Patent No. 6899061
Patent Literature 5: WO2021/154898A2

### Non-Patent Literature

Non-patent literature 1: Optical Circuit Packaging Technology Committee, Optical Circuit Packaging Technology Study Group, “Current status and future prospects of Co-Packaged Optics”, Journal of the Japan Institute of Electronics Packaging, Vol. 24, No. 1, 2021, pp. 38-42

### SUMMARY OF THE INVENTION

### Technical Problem

None of the resin compositions for the redistribution laver in the package structure of any of the above optical communication devices provides a resin composition that simultaneously takes into consideration optical properties such as refractive index in the near infrared, particularly in the C-Band around the optical communication wavelength of 1550 nm, and low dielectric properties required as an insulating resin for mounting electronics suitable for recent high frequency applications.

In view of the above circumstances, the present invention aims to provide a resin composition suitable for optical communication technology.

In addition, in order to realize highly integrated, energy-saving, and multifunctional devices through a variety of package structures for optoelectronic integrated packaging, the present invention aims to provide a resin composition suitable for filling gaps between chips, between chips and boards, etc., to protect wiring, which can be used as an insulating resin for redistribution layers of electronics and as a cladding resin for polymer optical waveguides.

### Solution to Problem

As a result of extensive research, the inventors have found that a composition containing a photocurable resin and a bismaleimide compound is useful as a resin composition for optical waveguides and have completed the present invention. The present invention also provides a resin composition that has both optical properties that enable a cladding function suitable for an optoelectronic integrated packaging process that simultaneously packages optical communications, and low dielectric properties required for insulation of a redistribution layer for electronics.

That is, the present invention relates to the following [1] to [10].
[1]A resin composition for optical waveguides, comprising a photocurable resin and a bismaleimide compound.
[2] A resin composition for optical waveguides, comprising a photocurable resin and a bismaleimide compound represented by the following general formula (1):

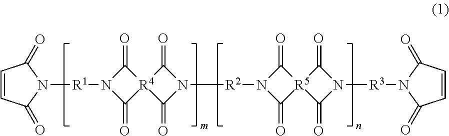

(In formula (1), R¹ represents a divalent hydrocarbon group derived from a dimer acid, R² represents a divalent organic group other than the divalent hydrocarbon group derived from the dimer acid, and R³ is R² or R¹. R⁴ and R⁵ each independently contain one or more organic groups selected from: a tetravalent organic group having 6 to 40 carbon atoms and having a monocyclic or condensed polycyclic alicyclic structure; a tetravalent organic group having 4 to 40 carbon atoms in which organic groups having a monocyclic alicyclic structure are bonded to each other directly or via a crosslinked structure; a tetravalent organic group having 4 to 40 carbon atoms and having a semi-alicyclic structure having both an alicyclic structure and an aromatic ring; and a tetravalent organic group having 4 to 40 carbon atoms and having an alicyclic structure or an aromatic ring having a halogenated alkyl group. n is 0 to 100, and n is 0 to 100. However, when n=m=0, R³ is R¹.)
[3] The resin composition for optical waveguide according to [2], wherein in the bismaleimide compound represented by the formula (1), the organic groups represented by R⁴ and R⁵ are any of the tetravalent organic groups represented by the following structural formulae (A-1) to (A-13).

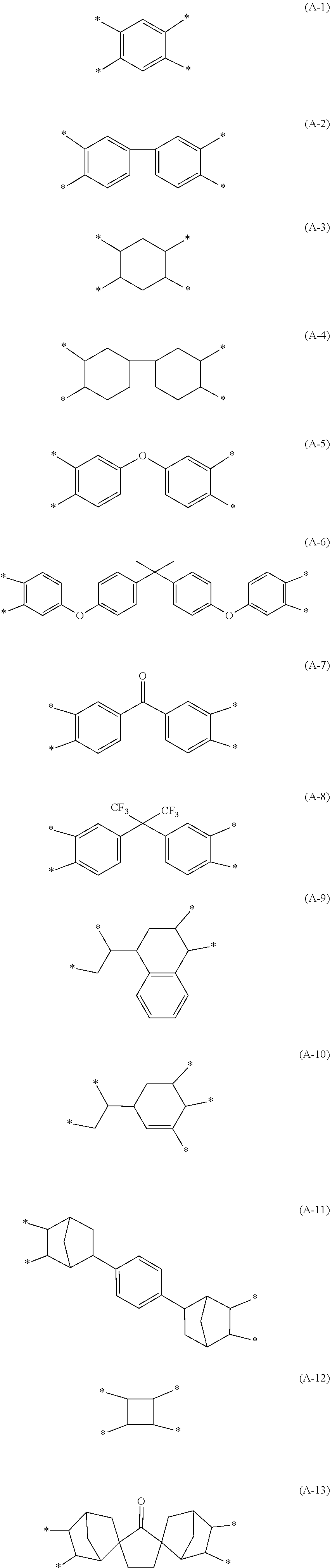

(The bonds represented by the marks * in the structural formulae are bonded to the carbonyl carbons that form a cyclic imide structure in the general formula (1).)
[4] The resin composition for optical waveguide according to [2], wherein in the bismaleimide compound represented by the above formula (1), the organic groups represented by R⁴ and R⁵ are any of the tetravalent organic groups represented by the structural formulae (A-3) to (A-6) and (A-8) to (A-11), and
   the bismaleimide compound has Hansen solubility parameters of a dispersion term dd of 16.6 MPa^{1/2} or more and 21.2 MPa^{1/2} or less, a polar term δp of 4.4 MPa^{1/2} or more and 9.0 MPa^{1/2} or less, and a hydrogen bond term δh of 4.4 MPa^{1/2} or more and 9.2 MPa^{1/2} or less.
[5]A resin composition for a substrate with an optical waveguide, comprising a photocurable resin and a bismaleimide compound represented by the above formula (1).
[6] The resin composition for a substrate with an optical waveguide according to [5], wherein in the bismaleimide compound represented by the above formula (1), the organic groups represented by R⁴ and R⁵ are any of the tetravalent organic groups represented by the above structural formulae (A-1) to (A-13).
[7] The resin composition for a substrate with an optical waveguide according to [5], wherein in the bismaleimide compound represented by the formula (1), the organic groups represented by R⁴ and R⁵ are any of the tetravalent organic groups represented by the formulae (A-3) to (A-6) and (A-8) to (A-11), and the bismaleimide compound has Hansen solubility parameters of a dispersion term δd of 16.6 MPa^{1/2} to 21.2 MPa^{1/2}, a polar term δp of 4.4 MPa^{1/2} to 9.0 MPa^{1/2}, and a hydrogen bond term dh of 4.4 MPa^{1/2} to 9.2 MPa^{1/2}.
[8]A resin film comprising the resin composition according to any one of [1] to [7].
[9]A cured product of the resin composition according to any one of [1] to [7].
[10] An optical circuit board comprising the cured product according to [9].

### Effect of the Invention

According to the present invention, it is possible to provide a resin composition suitable for optical communication technology.

Also, according to the present invention, it is possible to provide a resin composition for redistribution having a cladding function for a polymer waveguide in a co-package for optoelectronic integrated packaging.

### DESCRIPTION OF EMBODIMENTS

The resin composition for optical waveguide according to the present embodiment will be described. Note that the present invention is not limited to these examples, but is defined by the claims, and is intended to include all modifications within the meaning and scope of the claims.

In this specification, including the examples, “parts” and “%” are all based on mass unless otherwise specified.

In this specification, “(meth)acrylate” includes both methacrylate and acrylate.

The resin composition for optical waveguide according to the present embodiment contains a photocurable resin and a bismaleimide compound described below.

### <Photocurable Resin>

Examples of photocurable resins include (meth)acrylates having at least one (meth)acryloyl group in the molecule. Examples of such (meth)acrylates include (meth)acrylates selected from the group consisting of monofunctional (meth)acrylates, polyfunctional (meth)acrylates, polyfunctional urethane (meth)acrylates, polyfunctional epoxy (meth)acrylates, and polyfunctional poly ester (meth)acrylates.

Examples of monofunctional monomers include methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 4-tert-butyl cyclohexanol (meth)acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, and isobornyl (meth)acrylate; carboxyl group-containing monomers such as (meth)acrylic acid, (meth)acrylic acid dimer, carboxyethyl (meth)acrylate, carboxypentyl (meth)acrylate, and ω-carboxy-polycaprolactone (meth)acrylate; heterocycle-containing (meth)acrylates such as N-acryloylmorpholine, N-vinylpyrrolidone, N-vinylcaprolactam, N-acryloylpiperidine, N-methacryloylpiperidine, N-acryloylpyrrolidine, 3-(3-pyridine)propyl (meth)acrylate, and cyclic trimethylolpropane formal acrylate; maleimide monomers such as maleimide, N-cyclohexylmaleimide, and N-phenylmaleimide; N-substituted amide monomers such as (meth)acrylamide, N,N-dimethyl(meth)acrylamide, N,N-diethyl(meth)acrylamide, N-hexyl(meth)acrylamide, N-methyl(meth)acrylamide, N-butyl(meth)acrylamide, N-methylol(meth)acrylamide, and N-methylolpropane(meth)acrylamide; aminoalkyl(meth)acrylate monomers such as aminoethyl(meth)acrylate, aminopropyl(meth)acrylate, N,N-dimethylaminoethyl(meth)acrylate, and tert-butylaminoethyl(meth)acrylate; and succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide.

Examples of polyfunctional monomers include ethylene glycol di(meth)acrylate, polyethylene glycol di(meth)acrylate, polypropylene glycol di(meth)acrylate, neopentyl glycol di(meth)acrylate, tripropylene glycol di(meth)acrylate, di(meth)acrylate of an alkylene oxide adduct of bisphenol A, tetraethylene glycol di(meth)acrylate, hydroxypivalic acid neopentyl glycol di(meth)acrylate, 14-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyldiol di(meth)acrylate, 3-ethyl-1,8-octanediol di(meth)acrylate, di(meth)acrylate of EO adduct of bisphenol A, trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl]isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl]isocyanurate.

Among these, monofunctional and bifunctional (meth)acrylates are preferred because of their low viscosity. In particular, from the viewpoints of viscosity and compatibility with the maleimide resin, monofunctional epoxy acrylates containing a phenoxy group and 1,6-hexanediol diacrylate are preferred.

From the viewpoint of viscosity of the composition, the content of the phenoxy group-containing monofunctional epoxy acrylate is 10% by weight or less, preferably 1% by weight or less, based on 100% by weight of the resin component. The content of 1,6-hexanediol diacrylate is 3% by weight or more and 25% by weight or less, preferably 20% by weight or more and 25% by weight or less.

### <Bismaleimide Compound>

The bismaleimide compound is not particularly limited as long as it has maleimide structures at both ends of the molecule. The bismaleimide compound is preferably one having two or more imide structures.

The bismaleimide compound is preferably a bismaleimide compound represented by the following formula (1).

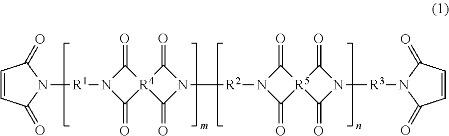

In the formula (1). R¹ represents a divalent hydrocarbon group derived from a dimer acid, R² represents a divalent organic group other than the divalent hydrocarbon group derived from the dimer acid, and R³ is R² or R¹. R⁴ and R⁵ each independently contain one or more organic groups selected from: a tetravalent organic group having 6 to 40 carbon atoms and having a monocyclic or condensed polycyclic alicyclic structure; a tetravalent organic group having 4 to 40 carbon atoms in which organic groups having a monocyclic alicyclic structure are bonded to each other directly or via a crosslinked structure; a tetravalent organic group having 4 to 40 carbon atoms and having a semi-alicyclic structure having both an alicyclic structure and an aromatic ring; and a tetravalent organic group having 4 to 40 carbon atoms and having an alicyclic structure or an aromatic ring having a halogenated alkyl group. n is 0 to 100, and m is 0 to 100. However, when n==m=0, R³ is R¹.

Here, the divalent hydrocarbon group derived from the dimer acid represented by R, in the formula (1) refers to a divalent residue obtained by removing two carboxy groups from a dicarboxylic acid contained in the dimer acid.

In this embodiment, the diner acid is obtained by dimerizing unsaturated bonds of unsaturated carboxylic acids having 18 carbon atoms, such as linoleic acids, oleic acids, and linolenic acid, and then purifying it by distillation. The dimer acid mainly contains a dicarboxylic acid having 36 carbon atoms, and usually contains a tricarboxylic acid having 54 carbon atoms up to about 5% by mass and a monocarboxylic acid up to about 5% by mass. The diamine derived from the dimer acid according to this embodiment (hereinafter, sometimes referred to as a diamine derived from dimer acid) is a diamine obtained by substituting two carboxyl groups of each dicarboxylic acid contained in the dimer acid with amino groups. Usually, the diamine derived from dimer acid is a mixture of multiple types. Examples of such a diamine derived from a dimer acid include diamines such as [3,4-bis(1-aminoheptyl)6-hexyl-5-(1-octenyl)]cyclohexane, and diamines in which the unsaturated bonds are saturated by further hydrogenating these diamines.

The divalent hydrocarbon derived from the dimer acid according to the present embodiment, which is introduced into the bismaleimide compound using such a diamine derived from a dimer acid, is preferably a residue obtained by removing two amino groups from the diamine derived from the dimer acid. When the diamine derived from the dimer acid is used to obtain the bismaleimide compound according to the present embodiment, the diamine derived from the dimer acid may be used alone or in combination with two or more diamines derived from dimer acids having different compositions. Furthermore, as such a diamine derived from a dimer acid, for example, a commercially available product such as “PRIAMINE 1074” (manufactured by Croda Japan Co., Ltd.) may be used.

The divalent organic group represented by R² in the formula (1) other than the divalent hydrocarbon group derived from the dimer acid is an alkylene group having 6 to 60 carbon atoms which may contain a heteroatom, or an arylene group having 6 to 30 carbon atoms which may contain a heteroatom. Preferably, it is an alkylene group having 8 to 40 carbon atoms which may contain a heteroatom, or an arylene group having 8 to 18 carbon atoms.

It is more preferable that R² in the above formula (1) is any one of an alkylene group having an aliphatic ring or an arylene group having an aromatic ring, as represented by the following structural formulae (B-1) to (B-4).

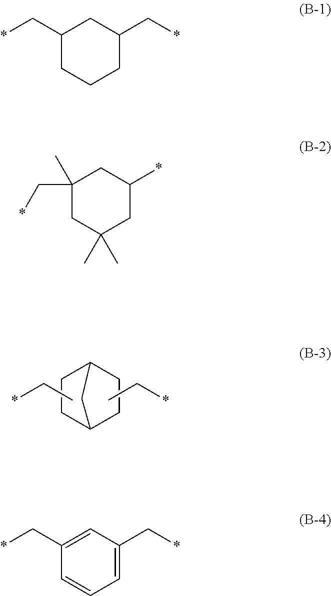

The bonds represented by the marks * in the structural formulae (B-1) to (B-4) are bonds to the nitrogen atom in the formula (1).

Here, the organic groups represented by R⁴ and R⁷ in the formula (1) are each independently a tetravalent organic group containing a cyclic structure and are particularly preferably any of the tetravalent organic groups represented by the following structural formulae (A-1) to (A-13).

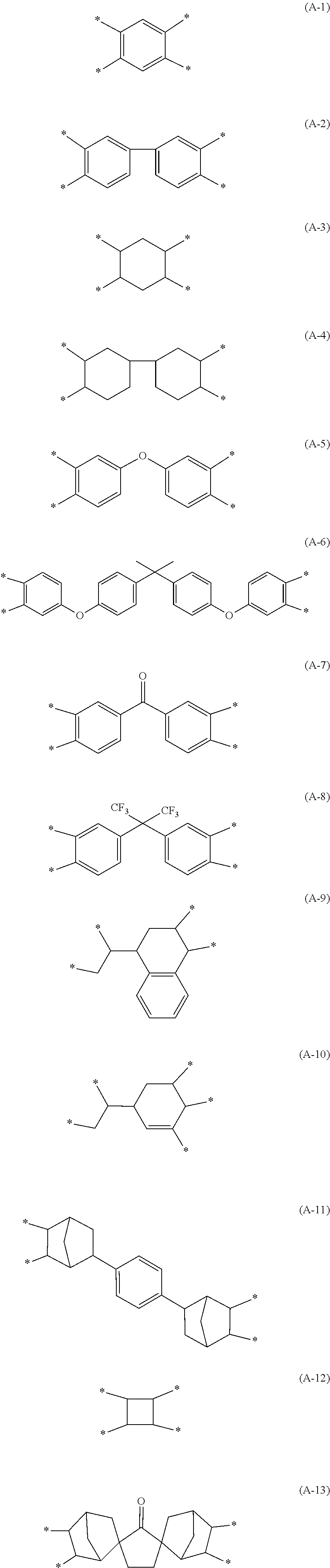

The bonds represented by the marks * in the structural formulae (A-1) to (A-13) are bonded to the carbonyl carbons that form the cyclic imide structure in the formula (1). The formula (A-10) is a structure derived from a tetracarboxylic dianhydride represented by the following structural formula (A-10-A).

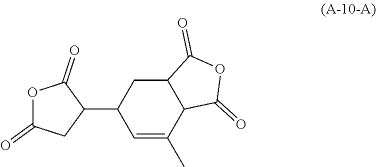

In the formula (1), m is the number of repeating units containing a divalent hydrocarbon group R¹ derived from a dimer acid (hereinafter, sometimes referred to as a structure derived from the dimer acid), and represents an integer of 0 to 100. From the viewpoint of favorable solubility in a developer during development, the value of m is particularly preferably 0 to 10.

In the formula (1), n is the number of repeating units (hereinafter sometimes referred to as a structure derived from an organic diamine) containing a divalent organic group R² other than the divalent hydrocarbon group derived from the dimer acid and represents an integer of 0 to 100. When the value of n is increased, the flexibility of the obtained cured product is deteriorated, resulting in a hard and brittle resin. From the viewpoint of the flexibility and elastic modulus of the cured product, it is particularly preferable that the value of n is 0 to 10.

Furthermore, in the bismaleimide compound represented by the formula (1), the structure derived from the dimer acid and the structure derived from the organic diamine may be random copolymerized or block copolymerized.

The bismaleimide compound represented by the formula (1) can be obtained by reacting a diamine derived from a dimer acid and, if necessary, an organic diamine other than the diamine derived from the dimer acid, with a tetracarboxylic dianhydride and maleic anhydrides.

The method of reacting a diamine derived from a dimer acid with a tetracarboxylic dianhydride and maleic anhydrides; or the method of reacting a diamine derived from a dimer acid and an organic diamine with a tetracarboxylic dianhydride and maleic anhydrides is not particularly limited, and any known method can be used as appropriate. For example, first, a diamine derived from a dimer acid, a tetracarboxylic dianhydride, and, if necessary, an organic diamine other than the diamine derived from the dimer acid, are stirred in a solvent such as toluene, xylene, tetralin, N,N-dimethylacetamide, N-methyl-2-pyrrolidone, or in a mixed solvent thereof, at room temperature (about 23° C.) for 30 to 60 minutes to synthesize a polyamic acid. Next, maleic acid is added to the obtained polyamic acid and stirred at room temperature (about 23° C.) for 30 to 60 minutes to synthesize a polyamic acid with maleic acids added at both ends. A solvent that forms an azeotrope with water, such as toluene, is added to the polyamic acid, and the mixture is refluxed at a temperature of 100 to 160° C. for 3 to 6 hours while removing water generated during the imidization, to obtain the desired bismaleimide compound. In this method, a catalyst, such as pyridine or methanesulfonic acid, may be further added.

The bismaleimide compound is preferably a bismaleimide compound having Hansen solubility parameters of a dispersion term δd of 16.6 MPa^{1/2} or more and 21.2 MPa^{1/2} or less, a polar term δp of 4.4 MPa^{1/2} or more and 9.0 MPa^{1/2} or less, and a hydrogen bond term δh of 4.4 MPa^{1/2} or more and 9.2 MPa^{1/2} or less.

The bismaleimide compound having Hansen solubility parameters of the dispersion term δd of 16.6 MPa^{1/2} or more and 21.2 MPa^{1/2} or less, a polar term δp of 4.4 MPa^{1/2} or more and 9.0 MPa^{1/2} or less, and a hydrogen bond term δh of 4.4 MPa^{1/2} or more and 9.2 MPa^{1/2} or less is preferably a bismaleimide represented by the formula (1). In the formula (1), the divalent hydrocarbon group derived from the dimer acid represented by R¹ and the divalent organic group represented by R² other than the divalent hydrocarbon group derived from the dimer acid are as described above.

In addition, when the divalent organic group other than the divalent hydrocarbon group derived from the dimer acid increases, the values of δp and δh increase and tend to exceed the above-mentioned parameter ranges. Therefore, as a bismaleimide compound that satisfies the Hansen solubility parameters, it is preferable that m and n in the formula (1) satisfies a ratio of m>n.

In the bismaleimide compound satisfying the Hansen solubility parameters, the organic groups represented by R⁴ and R⁵ in formula (1) are each independently a tetravalent organic group containing a cyclic structure, and are particularly preferably a tetravalent organic group having a six-membered alicyclic skeleton, a tetravalent organic group having an aromatic ring skeleton having a halogenated alkyl group, a tetravalent organic group having a monocyclic or condensed polycyclic alicyclic structure, or an organic group in which organic groups having a monocyclic alicyclic structure are bonded to each other directly or via a crosslinked structure. In particular, any of the tetravalent organic groups represented by the following structural formulae (A-3) to (A-6) and (A-8) to (A-11) is preferred.

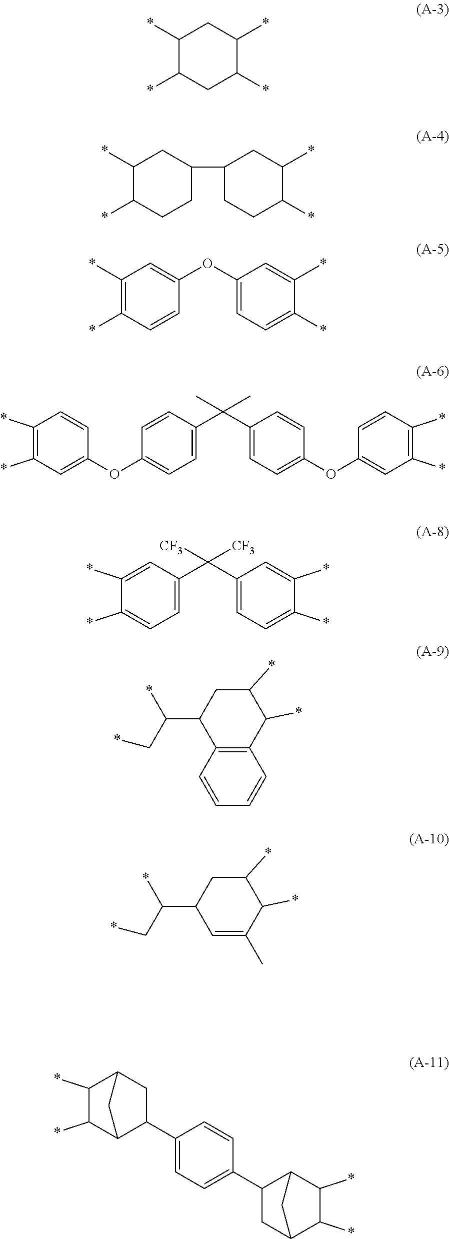

As the bismaleimide compound according to the present embodiment, a compound represented by the following formula (M-1), a compound represented by the following formula (M-2), a compound represented by the following formula (M-3), a compound represented by the following formula (M-4), a compound represented by the following formula (M-5), or a compound represented by the following formula (M-6) is preferable. Furthermore, as the bismaleimide compound according to the present embodiment, one type may be used alone, or two or more types may be used in combination. In the following formulae (M-1) to (M-5), n is preferably 1 to 10, and more preferably 1 to 3, from the viewpoint of compatibility.

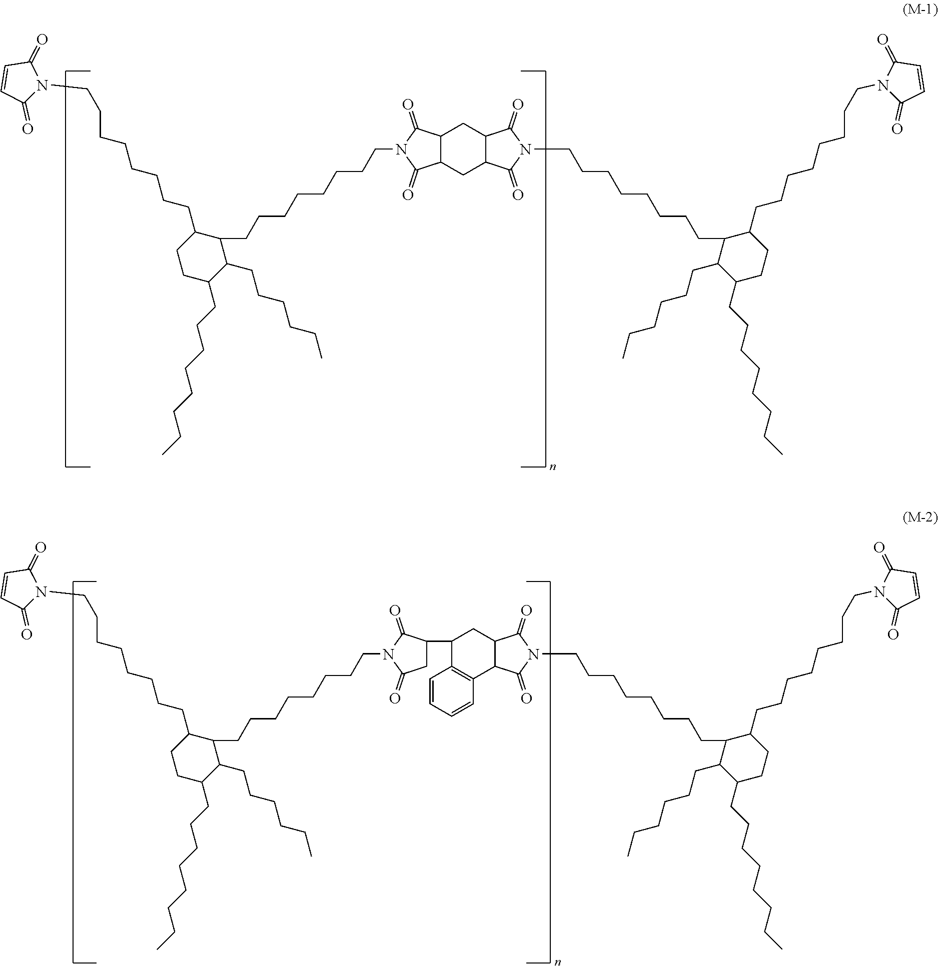

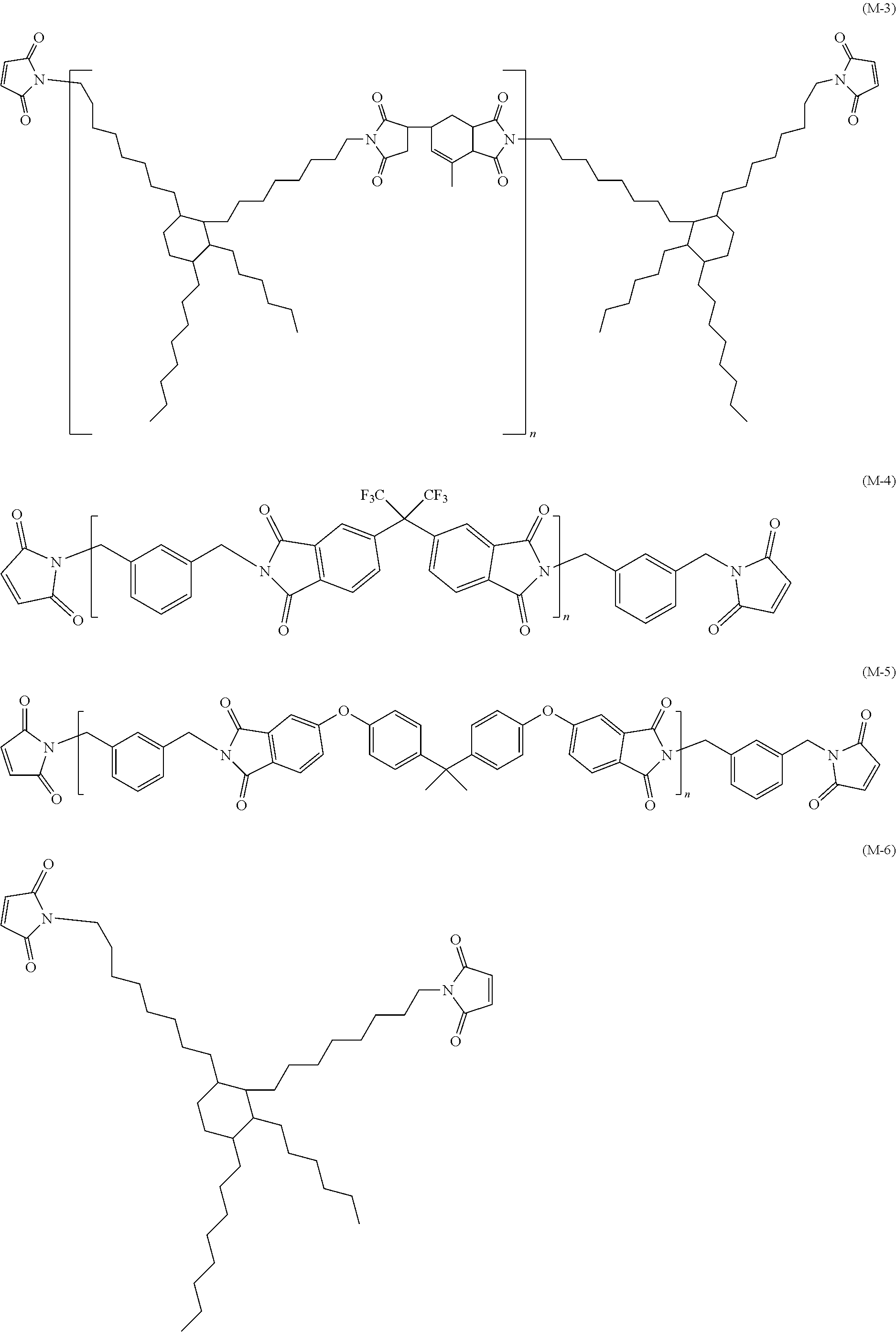

Here, the Hansen solubility parameters are solubility parameters introduced by Hildebrand, which are divided into three components, a dispersion term (δd), a polar term (δp), and a hydrogen bond term (δh), and expressed in a three-dimensional space. The dispersion term (μd) indicates the effect from dispersion forces, the polar term (μp) indicates the effect from dipolar intermolecular forces, and the hydrogen bond term (μh) indicates the effect from hydrogen bonding forces.

The definition and calculation method of Hansen's solubility parameters are described, for example, in “Hansen Solubility Parameters: A ser Handbook” by Charles M. Hansen, CRC Press, 2007, etc. Also, the calculation can be performed using computer software “Hansen Solubility Parameters in Practice (HSPiP)”.

In this experiment, a bismaleimide compound was actually mixed with 13 kinds of organic solvents (N,N-dimethyformamide, ethyl acetate, cyclopentanone, methanol, methyl ethyl ketone, methyl isobutyl ketone, N-methylpyrrolidone, anisole, isopropyl alcohol, propylene glycol monomethyl ether acetate, toluene, water, ethylene glycol diglycidyl ether) respectively in a ratio of 1:9, stirred, heated in a thermostatic bath at 80° C. for 1 hour to make the solutions uniform, and then left to stand overnight. The level of compatibility of the solution after standing overnight was counted from 1 to 6, and the results were entered into the software for calculation. Regarding the level of compatibility in this specification, level 1 indicates complete compatibility. Level 2 indicates a transparent solution with some cloudiness. Level 3 indicates that the entire solution is cloudy, or that some of the compounds have precipitated. Level 4 indicates that the compounds are swollen throughout the solution, or that more than half of the compounds are incompatible and have precipitated. Level 5 indicates that the solution is entirely suspended, or that only a portion of the compounds are compatible. Level 6 indicates that the compounds are not compatible or swollen at all, or that they are separated. The Hansen solubility parameters in this specification were calculated using HSPiP version 5.4.01.

From the viewpoint of viscosity and compatibility of the composition, the content of the bismaleimide compound is 60% by weight or more and 80% by weight or less, preferably 70% by weight or more and 80% by weight or less, based on 100% by weight of the resin component.

### <Photopolymerization Initiator>

The resin composition for optical waveguide according to this embodiment may contain a photopolymerization initiator described below. The photopolymerization initiator may be appropriately selected from known radical photopolymerization initiators. Examples of the photopolymerization initiator include: radical-type photocuring initiators such as: benzoins such as benzoin, benzoin methyl ether, benzoin ethyl ether, benzoin propyl ether, and benzoin isobutyl ether; organic peroxides such as benzoyl peroxide, lauroyl peroxide, acetyl peroxide, parachlorobenzoyl peroxide, and di-tert-butyl-di-perphthalate; phosphine oxides such as 2,4,6-trimethylbenzoyl-diphenyl-phosphine oxide, bis(2,4,6-trimethylbenzoyl)-phenylphosphine oxide, benzoyl-diphenyl-phosphine oxide, and bisbenzoyl-phenylphosphine oxide; acetophenones such as acetophenone, 2,2-diethoxy-2-phenylacetophenone, 1,1-dichloroacetophenone, 2-hydroxy-2-methyl-phenylpropan-1-one, diethoxyacetophenone, 1-hydroxycyclohexyl phenyl ketone, 2-methyl-1-[4-(methylthio)phenyl]-2-morpholinopropan-1-one, and 2-benzyl-2-dimethylamino-1-(4-morpholinophenyl)-butanone-1; anthraquinones such as 2-ethylanthraquinone, 2-t-butylanthraquinone, 2-chloroanthraquinone, and 2-amylanthraquinone; thioxanthones such as 2,4-diethylthioxanthone, 2-isopropylthioxanthone, and 2-chlorothioxanthone; ketals such as acetophenone dimethyl ketal and benzyl dimethyl ketal; benzophenones such as benzophenone, 4-benzoyl-4′-methyldiphenyl sulfide, and 4,4′-bismethylaminobenzophenone; oxime esters such as 1-[4-(phenylthio)phenyl]-1,2-octanedione 2-(O-benzoyloxime) and 1-[9-ethyl-6-(2-methylbenzoyl)-9H-carbazol-3-yl]ethanone-1-(O-acetyloxime), and cationic photopolymerization initiators such as: diazonium salts of Lewis acids, such as p-methoxiphenyldiazonium fluorophosphonate and N,N-diethylaminophenyldiazonium hexafluorophosphonate; iodonium salts of Lewis acids, such as diphenyliodonium hexafluorophosphonate and diphenyliodonium hexafluoroantimonate; sulfonium salts of Lewis acids, such as triphenylsulfonium hexafluorophosphonate and triphenylsulfonium hexafluoroantimonate; phosphonium salts of Lewis acids, such as triphenylphosphonium hexafluoroantimonate; other halides; triazine-based initiators; borate-based initiators; and other photoacid generators.

As the photopolymerization initiator, commercially available products may be used, for example, Omnirad (registered trademark) 369 (trade name) manufactured by IGM Resins B.V., Omnirad (registered trademark) 819 (trade name) manufactured by IGM Resins B.V, Omnirad (registered trademark) 819DW (trade name) manufactured by IGM Resins B.V, Omnirad (registered trademark) 907 (trade name) manufactured by IGM Resins B.V., Omnirad (registered trademark) TPO (trade name) manufactured by 1GM Resins B.V., Omnirad (registered trademark) TPO-G (trade name) manufactured by IGM Resins B.V, Omnirad (registered trademark) 784 (trade name) manufactured by BASF Corporation, Irgacure (registered trademark) OXE01 (trade name) manufactured by BASF Japan Ltd., Irgacure (registered trademark) OXE02 (trade name) manufactured by BASF Japan Ltd., Irgacure (registered trademark) OXE03 (trade name) manufactured by BASF Japan Ltd., and Irgacure (registered trademark) OXE04 (trade name) manufactured by BASF Japan Ltd. These photopolymerization initiators (C) can be used alone or in appropriate mixture of two or more kinds.

In this embodiment, the C-Band is a near-infrared optical communication signal of 1535-1565 nm, and is cited as a wavelength range that is generally used in optical communications using optical fibers. However, this does not prevent the use of optical communications using surrounding wavelength ranges such as the O-Band, S-Band, and L-Band.

The cured product of the resin composition for optical waveguides can simultaneously achieve two effects: 1) a low dissipation factor, and 2) a refractive index in the C-band (1550 nm) within a range that can be used for optical waveguides. In this specification, a refractive index within a range that can be used for optical waveguides means a value of less than 1.6 that is particularly suitable when the resin composition for optical waveguides is used as a cladding material. A refractive index of 1.6 or more can be said to be suitable as a core material in optical waveguides.

The resin composition for optical waveguide may be a resin composition or a resin film. The resin composition has flowability. The resin composition may be in a paste form. The paste form includes a liquid form.

The resin composition for an optical waveguide is preferably a photocurable material. When the resin composition is a resin film, the resin film is preferably a photocurable resin film.

The resin composition for optical waveguide is preferably cured by exposure (photocuring). Examples of light rays for exposure include ultraviolet rays, electron beams, and X-rays. Examples of light sources that can be used for ultraviolet irradiation include sunlight, chemical lamps, low-pressure mercury lamps, high-pressure mercury lamps, metal halide lamps, xenon lamps, and UV-LEDs. After exposure, post-baking may be performed to stabilize the physical properties of the cured product. The method of post-baking is not particularly limited, but is usually performed at 50 to 260° C. for 1 to 120 minutes using a hot plate, oven, or the like.

The cured product has a refractive index of about 1.4 at a wavelength of 1,550 nm, and is suitable as a material for forming an optical waveguide.

The resin composition for optical waveguide can also be used as a resin composition for a substrate with an optical waveguide. For example, a core material may be embedded in the resin composition for a substrate with an optical waveguide to form a plate, thereby forming a substrate with an optical waveguide having a built-in core material. In this case, the resin composition for a substrate with an optical waveguide also functions as a cladding material for the optical waveguide.

The present invention also covers an optical waveguide, an optical circuit board, or a substrate with an optical waveguide, which are produced using the resin composition for optical waveguide or the resin composition for substrate with optical waveguide.

In the optical waveguide of this embodiment, the resin composition can be used as both a clad forming material for forming the clad part of the optical waveguide and a core forming material for forming the core part, but is particularly suitable as a clad forming material because the cured product has a low refractive index.

In addition, for the optical waveguide, various materials that have been used to form the clad part and the core part of conventional optical waveguides, that is, materials that are cured by light irradiation or heat treatment, such as materials mainly composed of silicone resin, acrylic resin, vinyl resin, epoxy resin, polyimide resin, polyolefin resin, polynorbornene resin, etc., can be appropriately selected and adopted as the clad forming material and the core forming material. Specifically, the above-mentioned optical waveguide forming composition and various conventional materials can be selected and adopted as the respective forming materials so that the clad part formed by the clad forming material has a lower refractive index than the central part of the core part formed by the core forming material. The clad forming material may also contain a light absorbing material such as carbon black.

The method for producing the optical waveguide is not particularly limited. For example, the optical waveguide can be formed through a process of curing the optical waveguide forming composition of the present embodiment or the above-mentioned conventional materials by exposure (photocuring) or heating (thermal curing). As a representative example, the optical waveguide can be formed through a development process using a lithography technique using a photomask.

In addition, so-called “optical pins” (optical waveguides having a desired inclination angle with respect to the substrate surface), which are one form of optical waveguide, can also be suitably produced using the optical waveguide forming composition.

Optical waveguides having such a desired inclination angle can be suitably produced, for example, by using the manufacturing method described in WO2015/060190. Specifically, the optical waveguide can be produced by a method including the steps of (1) providing an anti-reflective film on a support, (2) disposing the optical waveguide forming composition on the anti-reflective film, exposing the optical waveguide forming composition to light incident from a non-perpendicular direction to the support surface through a photomask, and curing the composition, and (3) removing the unexposed optical waveguide forming composition by development.

The antireflective film is not particularly limited, but a preferred example is an antireflective film formed from the antireflective film-forming composition described in WO 2015/060190 (a polymerizable composition containing a reactive silicone compound obtained by polycondensing a diaryl silicate compound having a specific structure and an alkoxysilane compound having a specific structure in the presence of an acid or a base, and an ultraviolet absorber).

In addition, a graded-index type (GI type) optical waveguide can also be suitably produced using the above-mentioned optical waveguide forming composition, for example, using the manufacturing method described in WO2013/002013, i.e., an injection method (so-called mosquito method) in which a core curable resin is patterned into a clad curable resin using a dispenser.

### EXAMPLES

### [Preparation of Resin Composition]

### <Bismaleimide Compound>

The following four compounds were prepared as bismaleimide compounds.

### (A-1) Bismaleimide Compound

Synthesized according to Synthesis Example 1 of WO2020/203834. Mass average molecular weight (Mw): 3200 (above formula (M-3))

### (A-2) Bismaleimide Compound

Trade name “MIZ-001” manufactured by Nippon Kayaku Co., Ltd., mass average molecular weight (Mw): 3000 (above formula (M-1))

### (A-3) Bismaleimide Compound

Compound (A3) was synthesized according to Synthesis Example 4 of WO2020/203834. Mass average molecular weight (Mw): 3700 (above formula (M-2))

### (A-4) Bismaleimide Compound

Trade name “BMI-689” manufactured by Designer Molecules Inc., mass average molecular weight (Mw): 690 (above formula (M-6))

### <Photocurable Resin Monomer>

An epoxy acrylate monomer having a phenoxy group (manufactured by Nippon Kayaku Co., Ltd., product name “R-128H”) and 1,6-hexanediol diacrylate (HDDA) (manufactured by IGM Resins B.V, product name “Photomer 4017”) were prepared as photocurable resin monomers.

### <Photopolymerization Initiator>

2,4,6-trimethylbenzoyldiphenylphosphine oxide (manufactured by IGM Resins BV, trade name “Omnirad TPO”) was prepared as a photopolymerization initiator.

### <Resin Composition>

The above bismaleimide compound, a photocurable resin monomer, and a photopolymerization initiator were mixed to prepare a resin composition.

In Table 1, the numerical values of the bismaleimide compounds (A-1) to (A-4), the photocurable resin monomers (R-1281H. HDDA), and the photopolymerization initiator (TPO) are the contents (% by mass) based on the total amounts of the bismaleimide compounds, the photocurable resin monomers, and the photopolymerization initiator.

### [Preparation of Resin Film]

The resin composition was sandwiched between 5 mm thick glass substrates to which a 75 μm thick untreated PET film (manufactured by Teijin, product name “Teijin Tetron (registered trademark) Film, HSL Type”) was attached, the film thickness was adjusted using a 100 μm spacer, and the resin film was cured at 1800 mJ/cm² with a high-pressure mercury lamp (80 W/cm, ozone-free) to prepare a resin film.

The obtained resin film was used for the following evaluations.

### <Hansen Solubility Parameters>

The dispersion term (δd), polar term (δp), and hydrogen bond term (δh) of the Hansen solubility parameters of the bismaleimide compounds (A-1) to (A-4) were calculated using HSPiP version 5.4.01.

### <Compatibility>

Resin films that were transparent and clear in appearance were rated as “good”, and those that were cloudy were rated as “bad”.

### <Dielectric Constant and Dissipation Factor>

The resin films were cut into test pieces with a length of 80 mm and a width of 3 mm, and the dielectric properties (dielectric constant and dissipation factor) were measured by the cavity resonator perturbation method using a 10 GHz cavity resonator manufactured by AET Corporation.

### <Refractive Index>

A resin film was cut into a 50 mm square to serve as a test piece, and the reflectance of light with a wavelength of 1550 nm was measured. The refractive index was calculated from the reflectance using the Fresnel equation.

TABLE 1

| | Example 1 | Example 2 | Example 3 | Example 4 |
|---|---|---|---|---|
| A-1 | 71.33 | — | — | — |
| A-2 | — | 71.33 | — | — |
| A-3 | — | — | 71.33 | — |
| A-4 | — | — | — | 71.33 |
| R-128H | 0.99 | 0.99 | 0.99 | 0.99 |
| HDDA | 24.77 | 24.77 | 24.77 | 24.77 |
| TPO | 2.91 | 2.91 | 2.91 | 2.91 |
| δ d | 17.70 | 17.60 | 18.00 | 16.70 |
| δ p | 6.50 | 7.60 | 6.90 | 8.40 |
| δ h | 5.50 | 6.70 | 4.40 | 6.90 |
| Compatibility | Good | Good | Good | Good |
| Dielectric constant | 2.54 | 2.58 | 2.56 | 2.56 |
| Dissipation factor | 0.0077 | 0.0074 | 0.0075 | 0.0075 |
| Refractive index | 1.462 | 1.462 | 1.469 | 1.469 |
| (1550 nm) | | | | |

### INDUSTRIAL APPLICABILITY

The present invention provides a resin composition for optical waveguides having a refractive index applicable to optical waveguides at 1550 nm, which is suitable as a cladding material for polymer optical waveguides used to realize advanced integration of optoelectronic integrated packaging in which low-power optical communications are mixed and mounted on an electric communication board. Furthermore, a resin composition for redistribution layers of optical component mixed packages is provided, which has a refractive index applicable to optical waveguides as well as the low dielectric properties required for redistribution layers (RDLs) when mounting electronic IC chips.

This application claims priority based on Japanese Patent Application No. 2022-079430 filed on May 13, 2022.

1. A resin composition for optical waveguides, comprising a photocurable resin and a bismaleimide compound.

2. A resin composition for optical waveguides, comprising a photocurable resin and a bismaleimide compound represented by the following general formula (1): 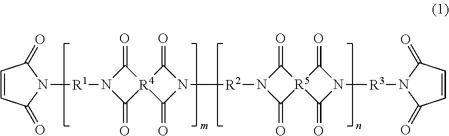
in formula (1), R¹ represents a divalent hydrocarbon group derived from a dimer acid, R² represents a divalent organic group other than the divalent hydrocarbon group derived from the dimer acid, and R³ is R² or R¹, R⁴ and R⁵ each independently contain one or more organic groups selected from: a tetravalent organic group having 6 to 40 carbon atoms and having a monocyclic or condensed polycyclic alicyclic structure; a tetravalent organic group having 4 to 40 carbon atoms in which organic groups having a monocyclic alicyclic structure are bonded to each other directly or via a crosslinked structure; a tetravalent organic group having 4 to 40 carbon atoms and having a semi-alicyclic structure having both an alicyclic structure and an aromatic ring; and a tetravalent organic group having 4 to 40 carbon atoms and having a alicyclic structure or an aromatic ring having a halogenated alkyl group, n is 0 to 100, and m is 0 to 100, but, when n=m=0, R³ is R¹.

3. The resin composition for optical waveguide according to claim 2, wherein in the bismaleimide compound represented by the formula (1), the organic groups represented by R⁴ and R⁵ are any of the tetravalent organic groups represented by the following structural formulae (A-1) to (A-13): 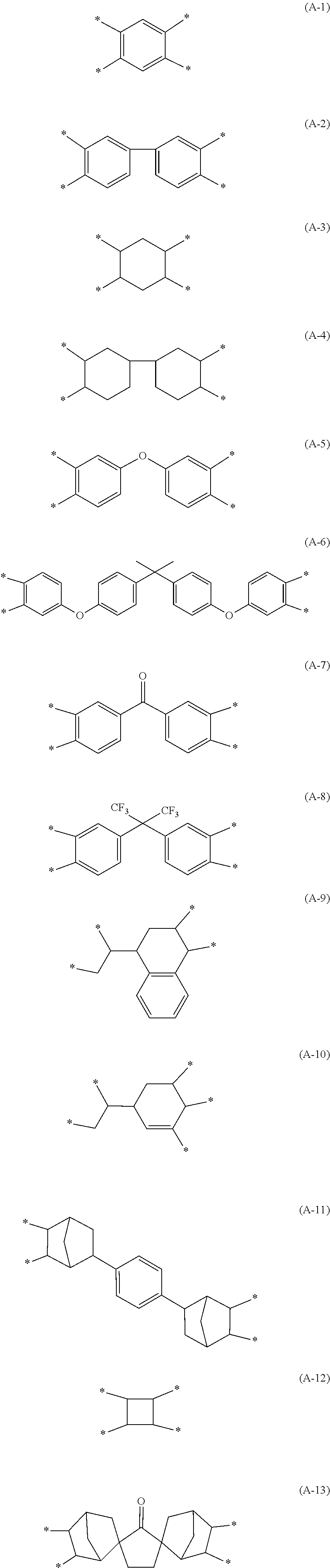
wherein bonds represented by the marks * in the structural formulae are bonded to carbonyl carbons that form a cyclic imide structure in general formula (1).

4. The resin composition for optical waveguide according to claim 2, wherein in the bismaleimide compound represented by formula (1), the organic groups represented by R⁴ and R⁵ are any of the tetravalent organic groups represented by the following structural formulae (A-3) to (A-6) and (A-8) to (A-11), and
the bismaleimide compound has Hansen solubility parameters of a dispersion term δd of 16.6 MPa^{1/2} or more and 21.2 MPa^{1/2} or less, a polar term δp of 4.4 MPa^{1/2} or more and 9.0 MPa^{1/2} or less, and a hydrogen bond term δh of 4.4 MPa^{1/2} or more and 9.2 MPa^{1/2} or less. 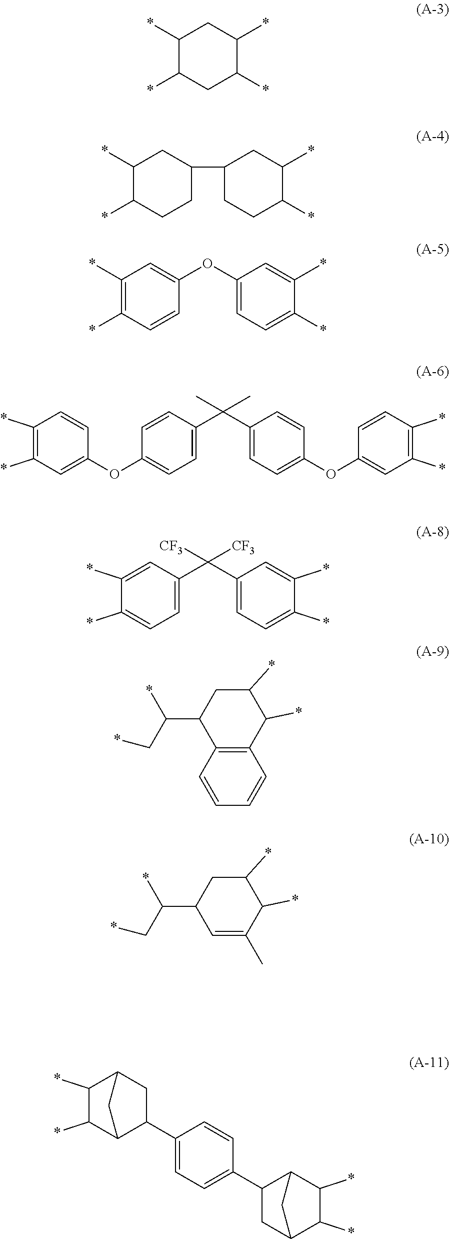
wherein bonds represented by marks * in the structural formulae are bonded to carbonyl carbons that form a cyclic imide structure in general formula (1).

5. A resin composition for a substrate with an optical waveguide, comprising a photocurable resin and a bismaleimide compound represented by the following general formula (1): 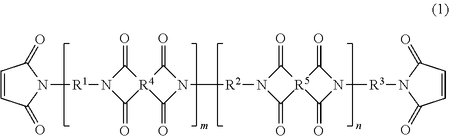
in formula (1), R¹ represents a divalent hydrocarbon group derived from a dimer acid, R² represents a divalent organic group other than the divalent hydrocarbon group derived from a dimer acid, and R³ is R² or R¹. R⁴ and R⁵ each independently contain one or more organic groups selected from a tetravalent organic group having 6 to 40 carbon atoms and a monocyclic or condensed polycyclic alicyclic structure, a tetravalent organic group having 4 to 40 carbon atoms in which organic groups having a monocyclic alicyclic structure are linked to each other directly or via a bridged structure, a tetravalent organic group having 4 to 40 carbon atoms and a semi-alicyclic structure having both an alicyclic structure and an aromatic ring, and a tetravalent organic group having 4 to 40 carbon atoms and an alicyclic structure or an aromatic ring having a halogenated alkyl group. n is 0 to 100, and in is 0 to 100. However, when n=m=0, R³ is R¹.

6. The resin composition for a substrate with an optical waveguide according to claim 5, wherein in the bismaleimide compound represented by the general formula (1), the organic groups represented by R⁴ and R⁵ are any of the tetravalent organic groups represented by the following structural formulae (A-1) to (A-13): 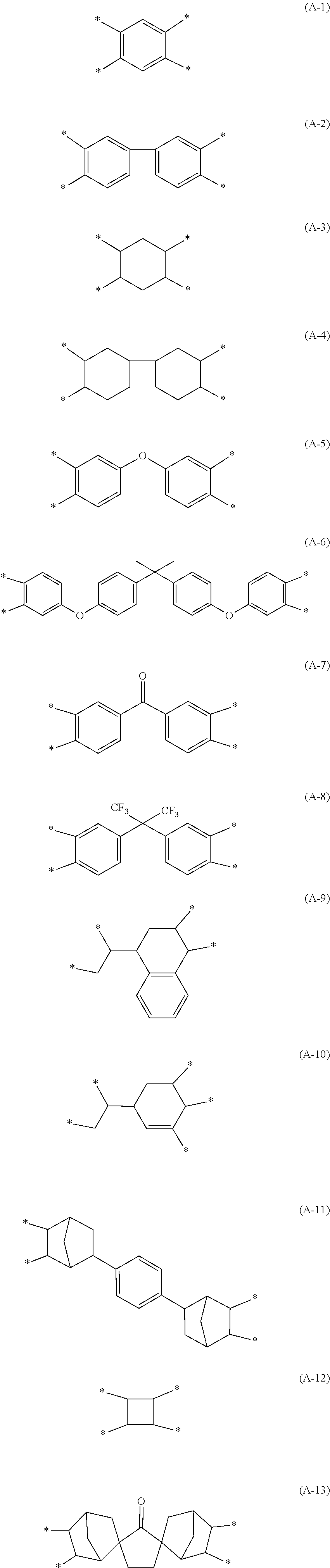
wherein the bonds represented by the marks * in the structural formulae are bonded to the carbonyl carbons that form a cyclic imide structure in the general formula (1).

7. The resin composition for a substrate with an optical waveguide according to claim 5, wherein in the bismaleimide compound represented by the general formula (1), the organic groups represented by R⁴ and R⁵ are any of the tetravalent organic groups represented by the following structural formulae (A-3) to (A-6) and (A-8) to (A-11), and
the bismaleimide compound has Hansen solubility parameters of a dispersion term δd of 16.6 MPa^{1/2} or more and 21.2 MPa^{1/2} or less, a polar term δp of 4.4 MPa^{1/2} or more and 9.0 MPa^{1/2} or less, and a hydrogen bond term δh of 4.4 MPa^{1/2} or more and 9.2 MPa^{1/2} or less: 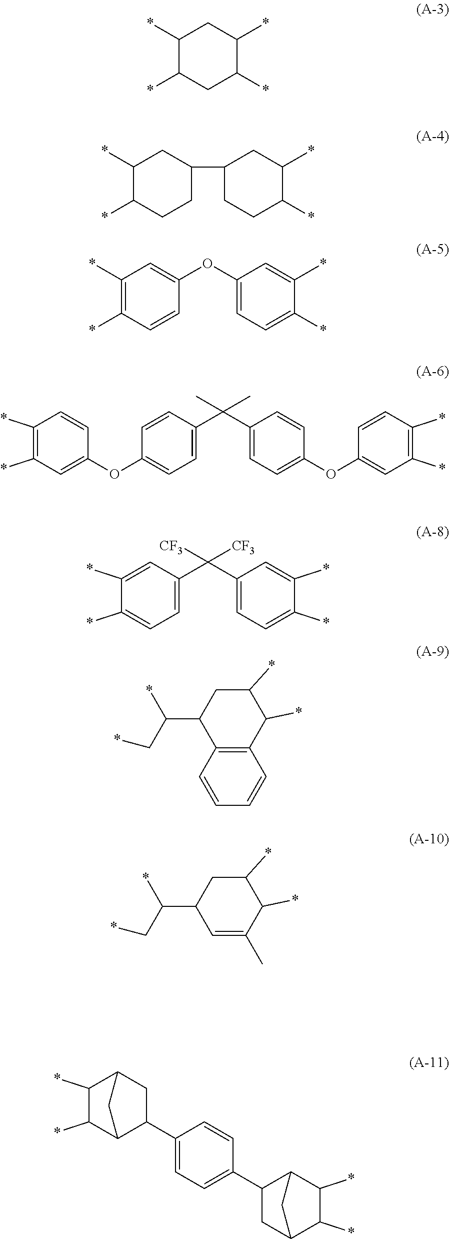
wherein bonds represented by the marks * in the structural formulae are bonded to carbonyl carbons that form a cyclic imide structure in the general formula (1).

8. A resin film comprising the resin composition according to claim 1.

9. A cured product of the resin composition according to claim 1.

10. An optical circuit board comprising the cured product according to claim 9.
